(19) United States
(12) Patent Application Publication
(10) Pub. No.: US 2017/0045763 A1
(43) Pub. Date: Feb. 16, 2017

(54) STEREOSCOPIC DISPLAY DEVICE

(71) Applicant: Sharp Kabushiki Kaisha, Osaka (JP)

(72) Inventors: Takehiro MURAO, Osaka (JP); Ryoh KIKUCHI, Osaka (JP); Takuto YOSHINO, Osaka (JP); Hiroshi FUKUSHIMA, Osaka (JP)

(73) Assignee: Sharp Kabushiki Kaisha, Osaka (JP)

(21) Appl. No.: 15/305,182

(22) PCT Filed: Feb. 26, 2015
(86) PCT No.: PCT/JP2015/055617

§ 371 Date: Oct. 19, 2016

(30) Foreign Application Priority Data
Apr. 22, 2014 (JP) 2014-088430

(51) Int. Cl. G02F 1/13; G02F 1/137; G02B 27/22; G02F 1/1337; G02F 1/1335; G02F 1/29; G02F 1/1343

(52) U.S. Cl. CPC G02F 1/1323; G02F 1/29; G02F 1/137; G02F 1/134327; G02F 1/133784; G02F 1/133528; G02B 27/2214; G02F 2001/133531; G02F 1/133345

(57) ABSTRACT

Provided is a configuration of a stereoscopic display device that can suppress light leakage in inter-wire regions and keep crosstalk to a minimum. A stereoscopic display device includes a display panel, switching liquid crystal panel, location sensor that acquires location information of a viewer, and a controller. The switching liquid crystal panel includes a first substrate and second substrate, a liquid crystal layer, a plurality of segment electrodes arranged with prescribed gaps therebetween along a first direction and each extending in a second direction orthogonal to the first direction, a first insulating film rubbed in a first rubbing direction that is at a 45° to 90° angle to the second direction, a common electrode, and a second alignment film covering the common electrode and rubbed in a second rubbing direction that is orthogonal to the first rubbing direction. The controller changes the potential of the plurality of segment electrodes in accordance with the location information of the viewer.

### TECHNICAL FIELD

The present invention relates to an autostereoscopic display device.

### BACKGROUND ART

Stereoscopic devices that can be viewed without glasses (autostereoscopic display devices) include parallax barrier schemes and lenticular lens schemes. These stereoscopic display devices use a barrier or lens that splits light in order to show different images to the left and right eye, thereby creating a three-dimensional appearance for the viewer. Autostereoscopic display devices on the market in recent years have mainly been two-viewpoint parallax barrier schemes and lenticular lens schemes.

In these types of two-viewpoint stereoscopic display devices, favorable stereoscopic display can be seen in defined areas, but if the user moves their head, it leads to areas with crosstalk, which is when the image intended for the right eye mixes and overlaps with the image intended for the left eye, or areas with so-called reverse viewing, which is when the image intended for the right eye is shown to the left eye. Thus, the viewer can only view stereoscopic images from a limited area. Proposals to solve this issue include multi-view techniques, and also tracking technology whereby the location of the head of the viewer is detected and images are displayed in accordance with this location.

There is also a proposal for a barrier-partitioned switching liquid crystal display (SW-LCD) scheme whereby a parallax barrier constituted by a liquid crystal panel is moved in accordance with the location of the viewer. In the SW-LCD scheme, if the formation parameters or the like of the parallax barrier are inappropriate, it could cause changes in luminance and worsening of crosstalk during switching of the parallax barrier.

Japanese Patent Application Laid-Open Publication No. 2013-24957 discloses a display device that includes a display panel in which sub-pixel pairs are arrayed horizontally, and a parallax barrier shutter panel in which sub-apertures capable of switching between a transmissive state and a light-blocking state are arrayed horizontally. In this display device, among the plurality of sub-apertures along the reference parallax barrier pitch, a random number of mutually adjacent sub-apertures are set to the transmissive state, and the remaining sub-apertures are set to the light-blocking state, thereby causing the total aperture to be formed in the parallax barrier shutter panel. The sub-aperture pitch is less than or equal to the difference between the sub-pixel width and the total aperture width.

### SUMMARY OF THE INVENTION

In the display device described in Japanese Patent Application Laid-Open Publication No. 2013-24957, transparent electrodes and a liquid crystal layer form the parallax barrier shutter panel. In order to keep the occurrence of crosstalk low even when the user moves their head, it is necessary to increase the number of electrodes. However, if the number of electrodes is increased, the proportion of the area of regions (inter-wire regions) between the electrodes to the area of electrodes increases. The response of liquid crystal in inter-wire regions is poor, and the light-blocking properties of the barrier could be lowered. As a result, it is possible that light leakage could occur in the inter-wire regions and that crosstalk could actually get worse.

An aim of the present invention is to achieve a stereoscopic display device that can suppress light leakage in inter-wire regions and maintain a low level of crosstalk.

The stereoscopic display device disclosed here includes a display panel, a switching liquid crystal panel overlapping the display panel, a location sensor that acquires location information of the viewer, and a controller that controls the switching liquid crystal panel. The switching liquid crystal display panel includes: a first substrate and a second substrate facing each other; a liquid crystal layer between the first substrate and the second substrate; a plurality of segment electrodes arranged on the first substrate with prescribed gaps therebetween along a first direction, each extending in a second direction orthogonal to the first direction; a first alignment film covering the plurality of segment electrodes and rubbed in a first rubbing direction that is at a 45° to 90° angle to the second direction; a common electrode on the second substrate; and a second alignment film covering the common electrode and rubbed in a second rubbing direction orthogonal to the first rubbing direction. The controller changes a potential of the plurality of segment electrodes in accordance with the location information of the viewer.

The present invention makes it possible to achieve a stereoscopic display device that can suppress light leakage in inter-wire regions and maintain a low level of crosstalk.

### BRIEF DESCRIPTION OF THE DRAWINGS

FIG. 1 is a schematic cross-sectional view showing a configuration of a stereoscopic display device according to Embodiment 1 of the present invention.

FIG. 2 is a block view showing a functional configuration of the stereoscopic display device according to Embodiment 1 of the present invention.

FIG. 3 is a flowchart of a process performed by the stereoscopic display device according to Embodiment 1 of the present invention.

FIG. 4A is a view for explaining stereoscopic display when the position of the parallax barrier is fixed.

FIG. 4B is a view for explaining stereoscopic display when the position of the parallax barrier is fixed.

FIG. 4C is a view for explaining stereoscopic display when the position of the parallax barrier is fixed.

FIG. 5A is a view for explaining the principles of stereoscopic display performed by the stereoscopic display device according to Embodiment 1 of the present invention.

FIG. 5B is a view for explaining the principles of stereoscopic display performed by the stereoscopic display device according to Embodiment 1 of the present invention.

FIG. 5C is a view for explaining the principles of stereoscopic display performed by the stereoscopic display device according to Embodiment 1 of the present invention.

FIG. 6 is a plan view showing a configuration of a first substrate of a switching liquid crystal panel.

FIG. 7 is a plan view showing a configuration of a second substrate of the switching liquid crystal panel.

FIG. 8 is a schematic cross-sectional view of the stereoscopic display device including a detailed configuration of the switching liquid crystal panel.

FIG. 9 is a schematic view showing the relationship between a rubbing direction DR1 of a first alignment film and segment electrodes.

FIG. 10 is a schematic view showing a relationship between the rubbing direction DR1 of the first alignment film and a rubbing direction DR2 of a second alignment film.

FIG. 11 is a schematic view showing a relationship between the rubbing direction DR1 of the first alignment film and the transmission axis of a polarizing plate.

FIG. 13A is a view for explaining one example of a method of manufacturing the first substrate.

FIG. 12B is a view for explaining one example of a method of manufacturing the first substrate.

FIG. 12C is a view for explaining one example of a method of manufacturing the first substrate.

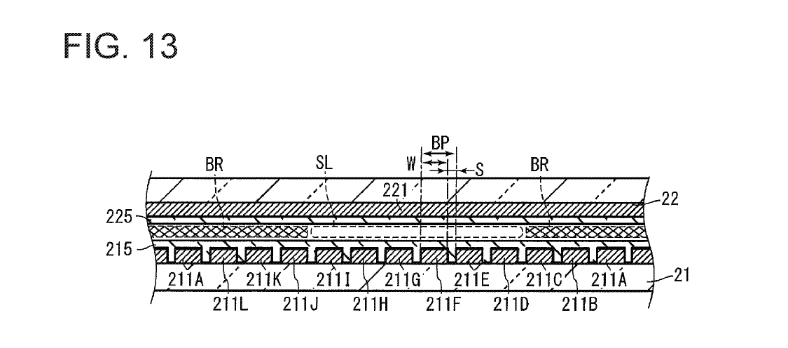

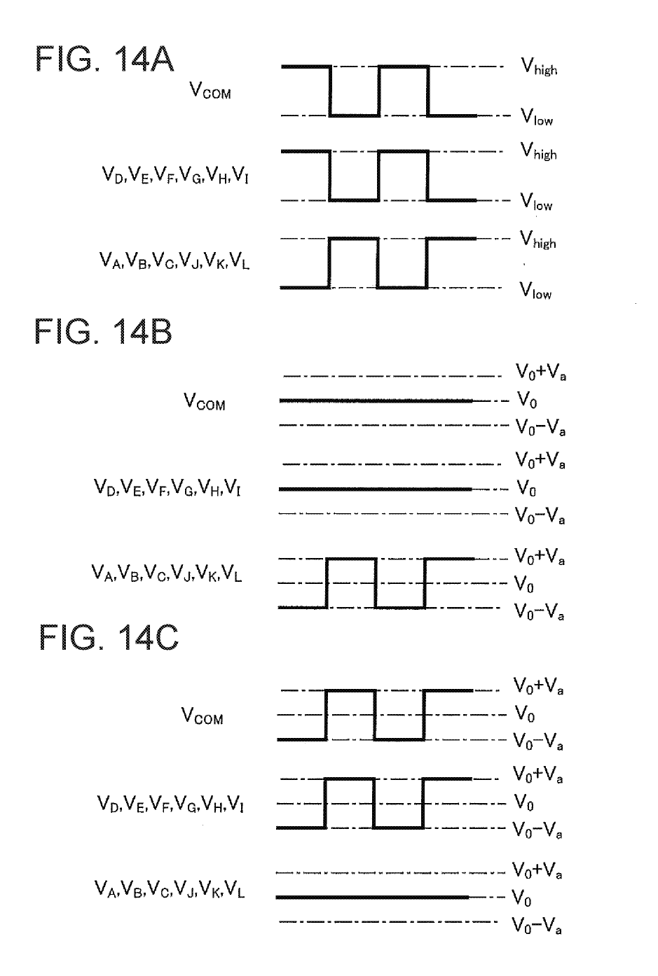

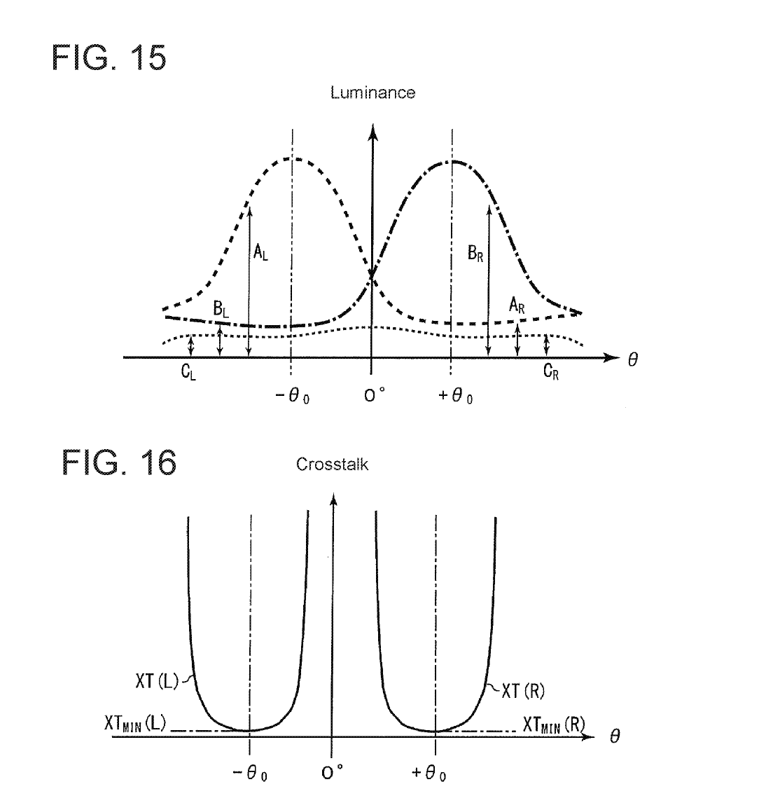

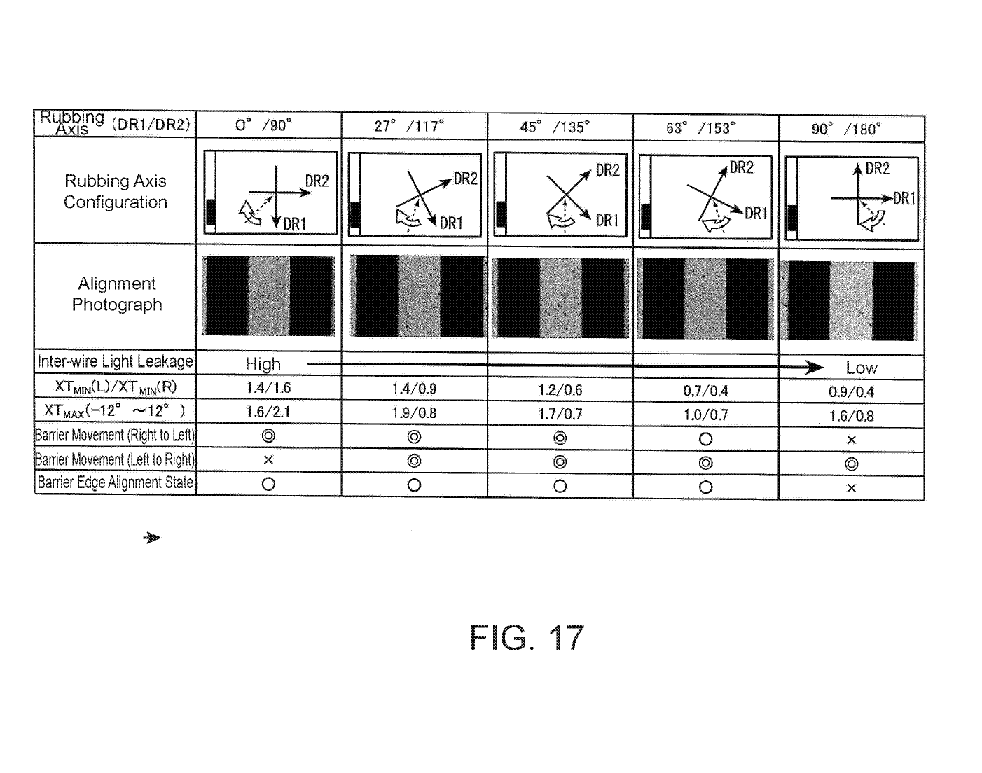

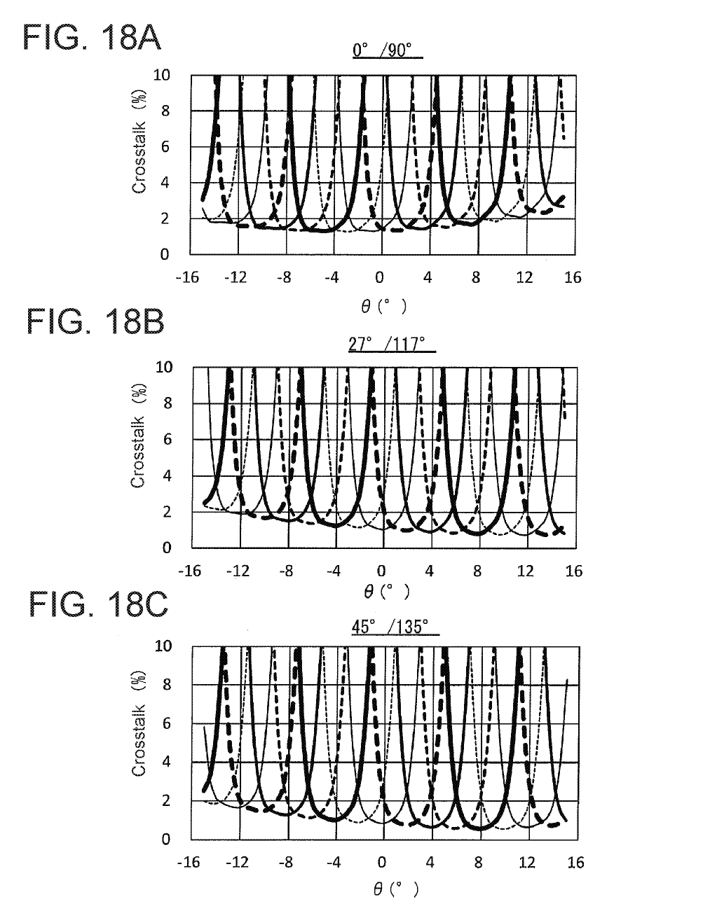

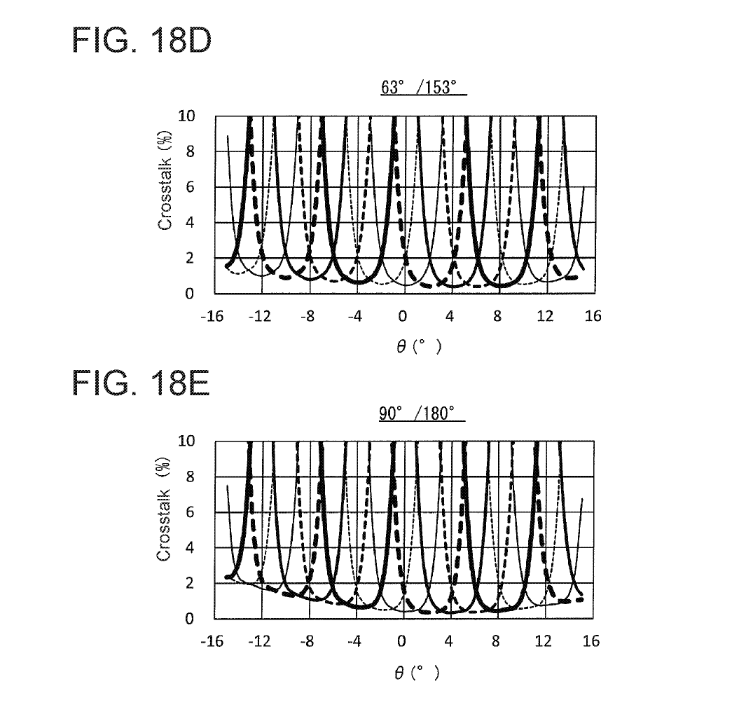

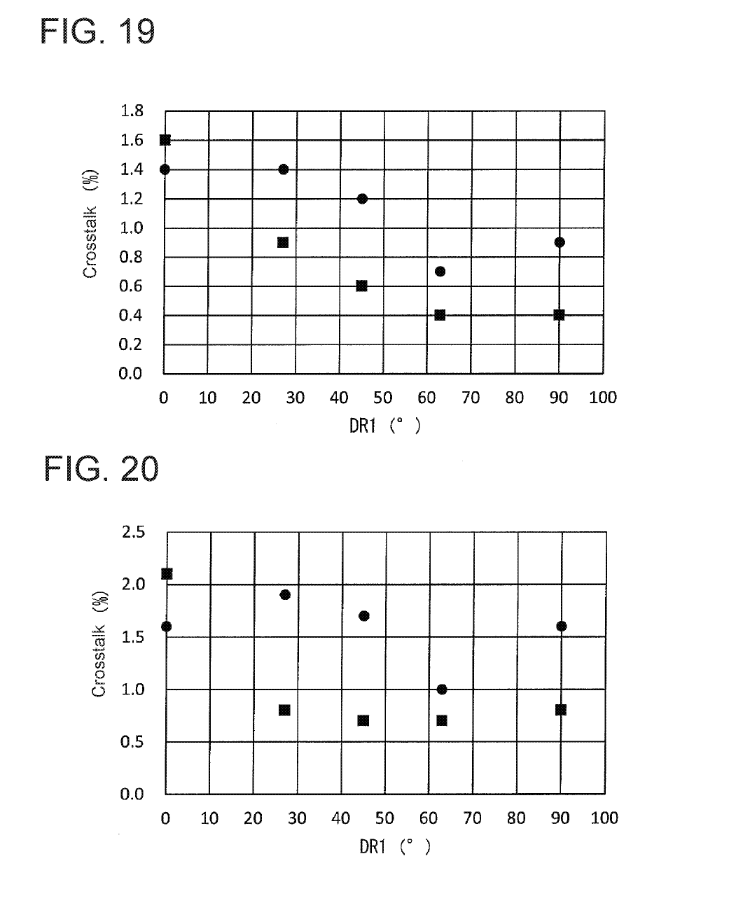

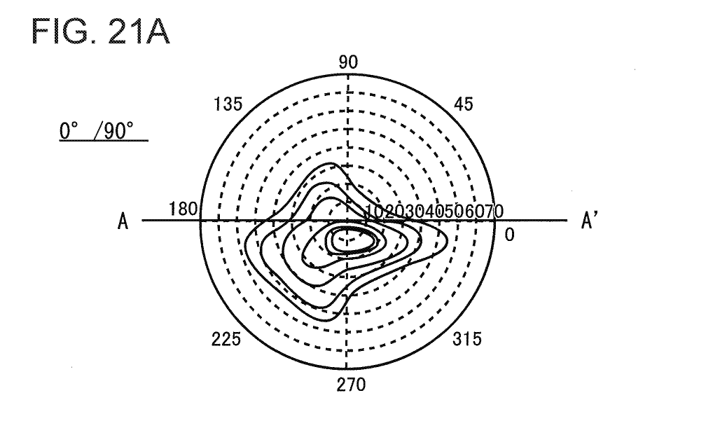

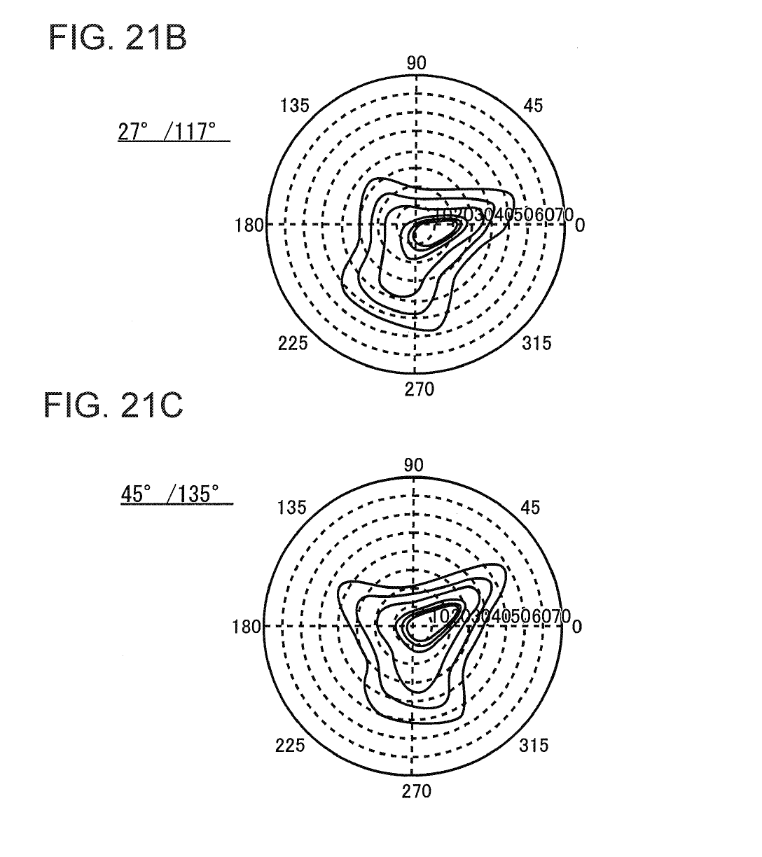

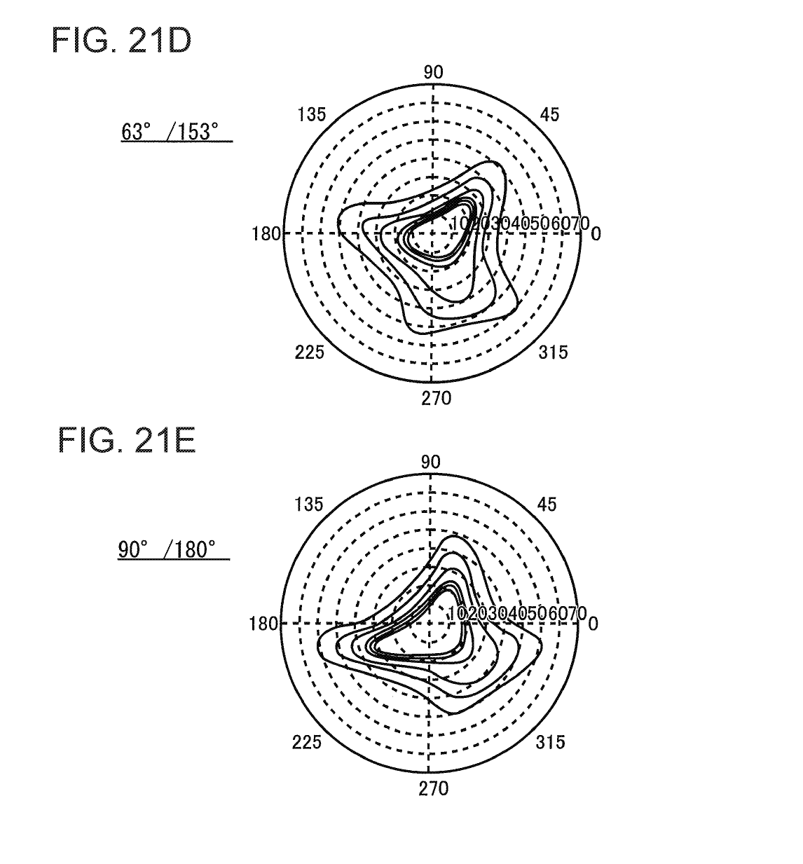

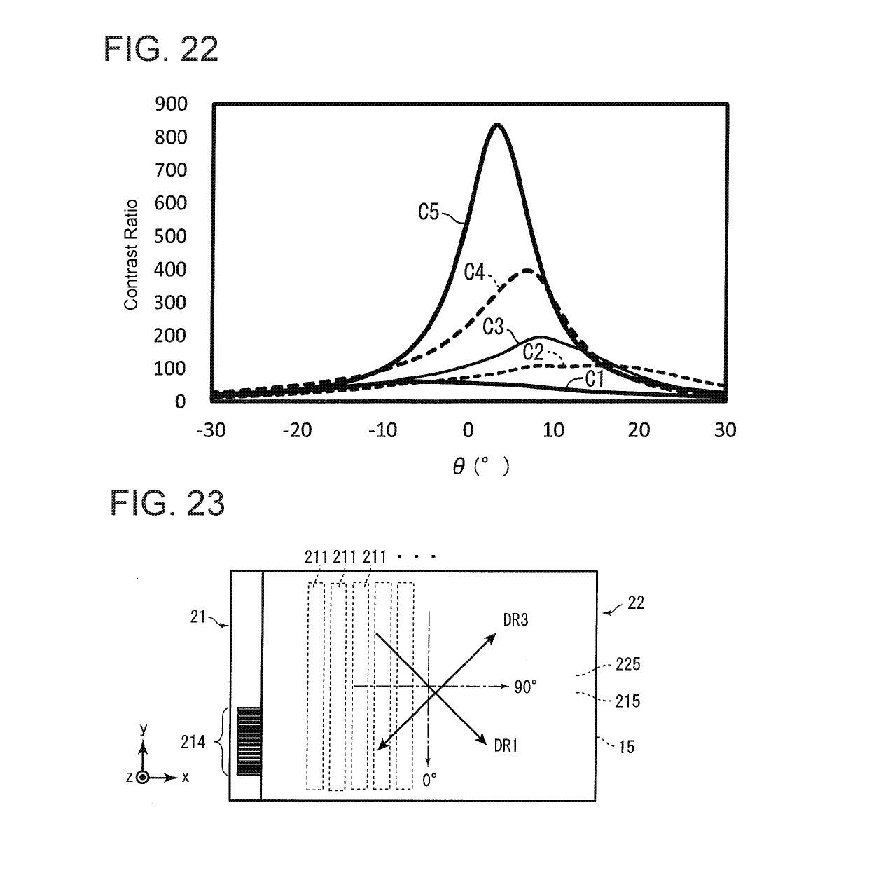

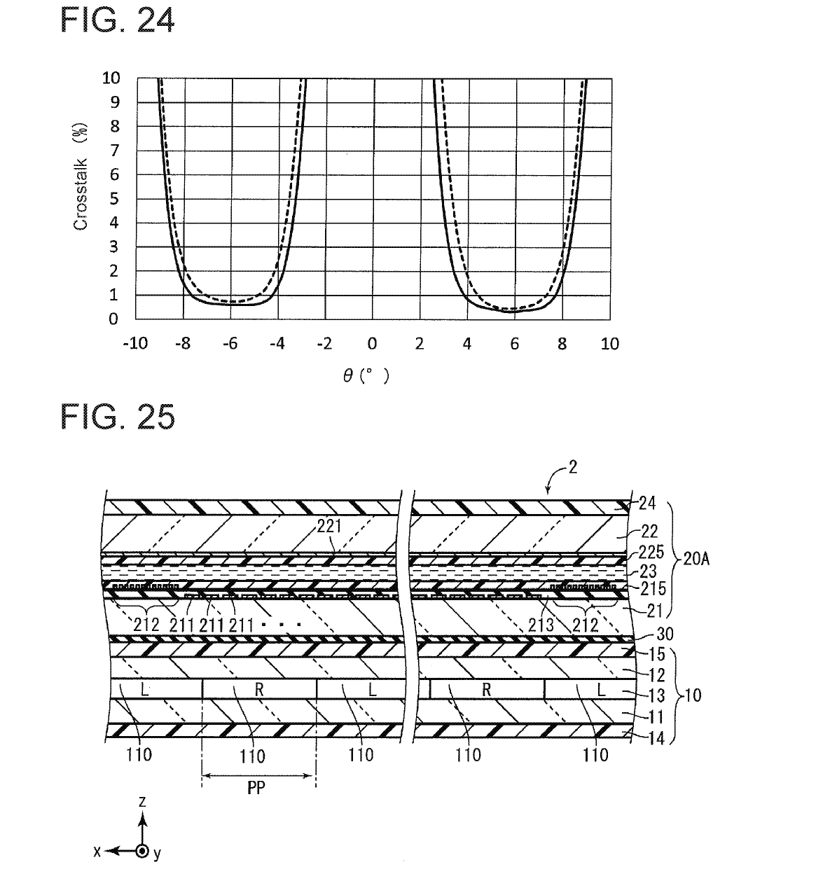

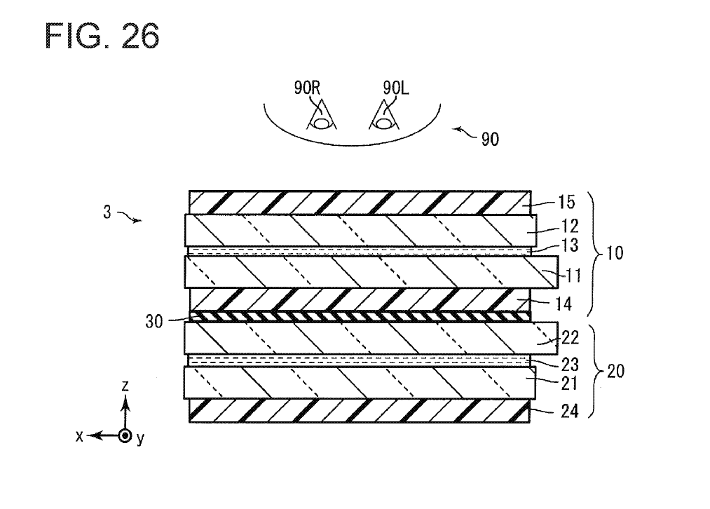

FIG. 13 is a cross-sectional view schematically showing one barrier lighting state displayed on the switching liquid crystal panel.

FIG. 14A is one example of a waveform diagram of signals supplied to the respective electrodes in order to put the switching liquid crystal panel into the barrier lighting state shown in FIG. 13.

FIG. 14B is another example of a waveform diagram of signals supplied to the respective electrodes in order to put the switching liquid crystal panel into the barrier lighting state shown in FIG. 13.

FIG. 14C is yet another example of a waveform diagram of signals supplied to the respective electrodes in order to put the switching liquid crystal panel into the barrier lighting state shown in FIG. 13.

FIG. 15 shows angle properties of the luminance of the stereoscopic display device when the barrier lighting state is fixed.

FIG. 16 shows angle properties of left-eye crosstalk XT (L) and right-eye crosstalk XT (R).

FIG. 17 is a table summarizing the relationship between rubbing direction and crosstalk.

FIG. 18A shows overlapping crosstalk properties when the barrier lighting state has been changed in the stereoscopic display device while the rubbing direction DR1=0°.

FIG. 18B shows overlapping crosstalk properties when the barrier lighting state has been changed in the stereoscopic display device while the rubbing direction DR1=27°.

FIG. 18C shows overlapping crosstalk properties when the barrier lighting state has been changed in the stereoscopic display device while the rubbing direction DR1=45°.

FIG. 18D shows overlapping crosstalk properties when the barrier lighting state has been changed in the stereoscopic display device while the rubbing direction DR1=63°.

FIG. 18E shows overlapping crosstalk properties when the barrier lighting state has been changed in the stereoscopic display device while the rubbing direction DR1=90°.

FIG. 19 is a graph showing the relationship between the rubbing direction DR1 and XT_{MIN}(L) and XT_{MIN} (R).

FIG. 20 is a graph showing the relationship between the rubbing direction DR1 and XT_{MAX} (−12° to 12°).

FIG. 21A shows contrast properties of the switching liquid crystal panel when the rubbing direction DR1=0°.

FIG. 21B shows contrast properties of the switching liquid crystal panel when the rubbing direction DR1=27°.

FIG. 21C shows contrast properties of the switching liquid crystal panel when the rubbing direction DR1=45°.

FIG. 21D shows contrast properties of the switching liquid crystal panel when the rubbing direction DR1=63°.

FIG. 21E shows contrast properties of the switching liquid crystal panel when the rubbing direction DR1=90°.

FIG. 22 is a graph showing contrast properties along the line A-A′ in FIG. 21A in each switching liquid crystal panel.

FIG. 23 is a schematic view showing the relationship between a rubbing direction DR1 of a first alignment film and a transmission axis DR3 of a polarizing plate in Embodiment 2.

FIG. 24 is a graph showing the crosstalk properties of the stereoscopic display device of Embodiment 1 and the stereoscopic display device of Embodiment 2.

FIG. 25 is a schematic cross-sectional view of a stereoscopic display device according to Embodiment 3 of the present invention.

FIG. 26 is a schematic cross-sectional view of a stereoscopic display device according to Embodiment 4 of the present invention.

### DETAILED DESCRIPTION OF EMBODIMENTS

A stereoscopic display device according to one embodiment of the present invention includes a display panel; a switching liquid crystal panel overlapping the display panel; a location sensor that acquires location information of a viewer; and a controller that controls the switching liquid crystal panel. The switching liquid crystal display panel includes: a first substrate and a second substrate facing each other; a liquid crystal layer between the first substrate and the second substrate; a plurality of segment electrodes arranged on the first substrate with prescribed gaps therebetween along a first direction, each extending in a second direction orthogonal to the first direction; a first alignment film covering the plurality of segment electrodes and rubbed in a first rubbing direction that is at a 45° to 90° angle to the second direction; a common electrode on the second substrate; and a second alignment film covering the common electrode and rubbed in a second rubbing direction orthogonal to the first rubbing direction. The controller changes a potential of the plurality of segment electrodes in accordance with the location information of the viewer (first configuration).

According to the configuration described above, the switching liquid crystal panel is placed so as to overlap the display panel. The switching liquid crystal panel includes the first substrate on which the plurality of segment electrodes are formed, and the second substrate on which the common electrode is formed. The plurality of segment electrodes are arranged along the first direction with prescribed gaps therebetween and each extend in the second direction, which is orthogonal to the first direction. The first substrate and second substrate face each other across the liquid crystal layer. The first substrate has the first alignment film, which is rubbed in the first rubbing direction, and the second substrate has the second alignment film, which is rubbed in the second rubbing direction. The first rubbing direction and second rubbing direction are orthogonal to each other. In other words, the switching liquid crystal panel has twisted nematic liquid crystal.

The controller changes the potential of the plurality of segment electrodes in accordance with the location information of the viewer supplied from the location sensor. This forms an electric field between the segment electrodes and the common electrode. This electric field changes the orientation state of the liquid crystal molecules and forms a parallax barrier based on the location information of the viewer. However, in the regions (inter-wire regions) between the segment electrodes, it is hard to control the electric field, and thus the response of the liquid crystal is poor. Therefore, the light-blocking properties of the barriers in the inter-wire regions become lower.

The angular distribution of the light-blocking properties of the barriers changes via the rubbing direction of the alignment film. Specifically, if the angle of the first rubbing direction to the second direction is 45° to 90°, it is possible to markedly suppress inter-wire light leakage. This is due to the following. When the angle of the rubbing direction D1 to the extension direction of the segment electrodes is large enough, rubbing becomes insufficient at the borders of areas where the segment electrodes are formed and areas where the segment electrodes are not formed. In areas where rubbing is insufficient, the liquid crystal molecules become unstable and over-responsive, even if the electric field is small. Furthermore, the orientation direction of the liquid crystal in the inter-wire regions becomes close to the segment electrodes in the vertical direction, which makes it easier to respond to electric fields. This makes it possible to improve the light-blocking properties of the inter-wire regions and maintain a low level of crosstalk.

The above-mentioned first configuration may further include a first polarizing plate and a second polarizing plate facing each other with the switching liquid crystal panel interposed therebetween, and the first polarizing plate may be on a side of the first substrate and may have a transmission axis parallel to the first rubbing direction, and the second polarizing plate may be on a side of the second substrate and may have a transmission axis parallel to the second rubbing direction (second configuration).

The above-mentioned first configuration may further include a first polarizing plate and a second polarizing plate facing each other with the switching liquid crystal panel interposed therebetween, and the first polarizing plate may be on a side of the first substrate and may have a transmission axis perpendicular to the first rubbing direction, and the second polarizing plate may be on a side of the second substrate and may have a transmission axis perpendicular to the second rubbing direction (third configuration).

With this configuration, the light focusing effect (lens effect) of the switching liquid crystal panel becomes greater, which makes it possible to further reduce crosstalk.

In any one of the first to third configurations, the display panel may be a liquid crystal panel (fourth configuration).

### EMBODIMENTS

Embodiments of the present invention will be described in detail below with reference to the drawings. Portions in the drawings that are the same or similar are assigned the same reference characters and descriptions thereof will not be repeated. For ease of description, drawings referred to below show simplified or schematic configurations, and some of the components are omitted. Components shown in the drawings are not necessarily to scale.

### Embodiment 1

### Overall Configuration

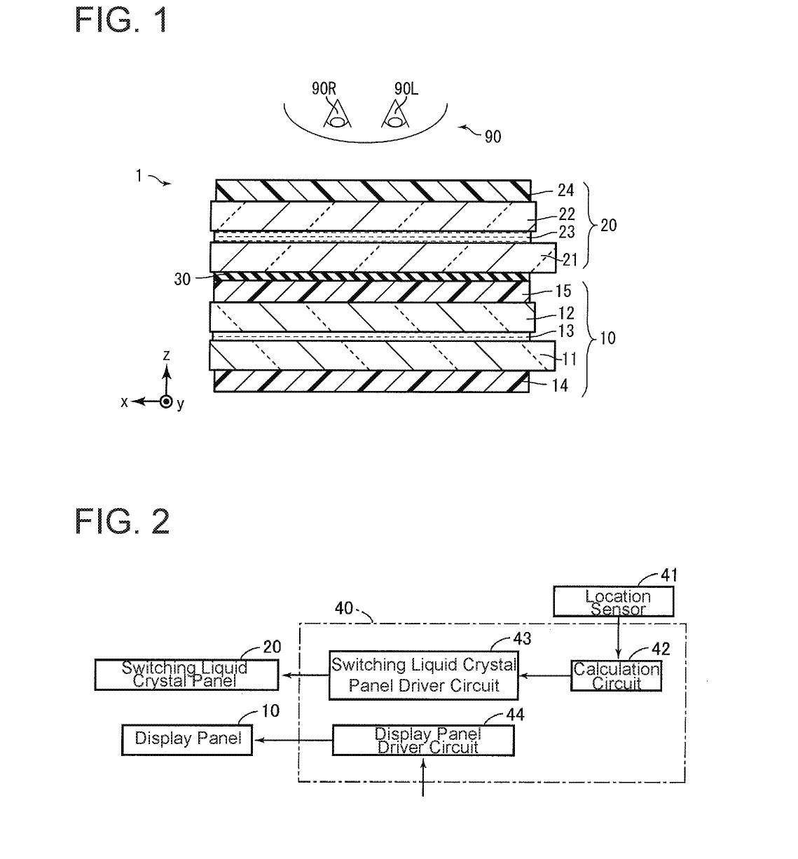

FIG. 1 is a schematic cross-sectional view showing a configuration of a stereoscopic display device according to Embodiment 1 of the present invention. A stereoscopic display device 1 includes a display panel 10, a switching liquid crystal panel 20, and an adhesive resin 30. The display panel 10 and the switching liquid crystal panel 20 are overlapped such that the switching liquid crystal panel 20 is on the side of the viewer 90 and then bonded together by the adhesive resin 30.

The display panel 10 includes a TFT (thin film transistor) substrate 11, a CF (color filter) substrate 12, a liquid crystal layer 13, a polarizing plate 14, and a polarizing plate 15 (first polarizing plate). The display panel 10 displays images by controlling the TFT substrate 11 and CF substrate 12 and manipulating the orientation of the liquid crystal molecules in the liquid crystal layer 13.

The switching liquid crystal panel 20 includes a first substrate 21, a second substrate 22, a liquid crystal layer 23, and a polarizing plate 24 (second polarizing plate). The first substrate 21 and the second substrate 22 are disposed so as to face each other. The liquid crystal layer 23 is sandwiched between the first substrate 21 and the second substrate 22. The polarizing plate 24 is disposed on the side of the viewer 90.

Although a detailed configuration is not shown in FIG. 1, the first substrate 21 and the second substrate 22 each have electrodes formed thereon. The switching liquid crystal panel 20 controls the potential of these electrodes to manipulate the orientation of the liquid crystal molecules inside the liquid crystal layer 23, which causes the behavior of light passing through the liquid crystal layer 23 to change. More specifically, the switching liquid crystal panel 23 forms non-transmissive areas (barriers) that block light and transmissive areas (slits) that transmit light due to the effects of the orientation of the liquid crystal molecules in the liquid crystal layer 23 and the polarizing plate 15 & polarizing plate 24. A detailed configuration of the first substrate 21, second substrate 22, and operation are described later.

The polarizing plates 15 and 24 are disposed such that the transmission axes are orthogonal to each other. The switching liquid crystal panel 20 is a so-called “normally white” display in which transmittance is greatest when voltage is not being applied to the liquid crystal layer 23. The normally white display in two-dimensional display mode is a state in which no voltage is being applied, and can thus reduce energy consumption during two-dimensional display when stereoscopic display is not being performed.

Alternatively, the polarizing plate 15 may be placed on the switching liquid crystal panel 20. In other words, the polarizing plate 15 may be placed on the surface of the first substrate 21 of the switching liquid crystal panel 20 facing the display panel 10, and an adhesive resin 30 may be placed between the polarizing plate 15 and the CF substrate 12.

Hereinafter, the direction (x direction in FIG. 1) parallel to a line segment connecting the left eye 90L and right eye 90R of the viewer 90 when the viewer 90 is directly facing the stereoscopic display device 1 will be referred to as the horizontal direction (first direction). Furthermore, the direction (y direction in FIG. 1) perpendicular to the horizontal direction in the plane of the display panel 10 will be referred to as the vertical direction (second direction).

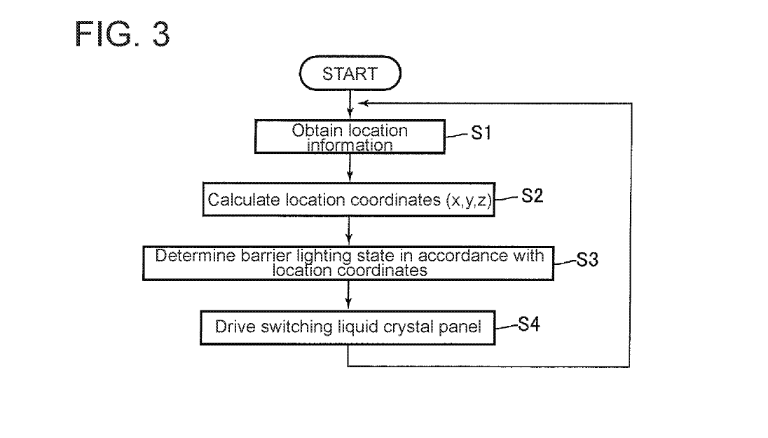

FIG. 2 is a block diagram showing a functional configuration of the stereoscopic display device 1. FIG. 3 is a flow chart of a process performed by the stereoscopic display device 1. The stereoscopic display device 1 further includes a controller 40 and a location sensor 41. The controller 40 includes an arithmetic circuit 42, a switching liquid crystal panel driver circuit 43, and a display panel driver circuit 44.

The display panel driver circuit 44 drives the display panel 10 in accordance with an image signal received from outside and causes an image to be displayed on the display panel 10.

The location sensor 41 acquires location information of the viewer 90 (step S1). The location sensor 41 is a camera or infrared sensor, for example. The location sensor 41 supplies the acquired location information to the arithmetic circuit 42 of the controller 40.

The arithmetic circuit 42 analyzes the location information of the viewer 90 supplied from the location sensor 41 and calculates location coordinates (x,y,z) of the viewer 90 (step S2). The calculation of the location coordinates can be performed by an eye tracking system that detects the location of the eyes of the viewer 90 via image processing, for example. Alternatively, the calculation of the location coordinates may be performed by a head tracking system that detects the location of the head of the viewer 90 via infrared rays.

The arithmetic circuit 42 further determines a barrier lighting state of the switching liquid crystal panel 20 in accordance with the location coordinates of the viewer 90 (step S3). In other words, the location of the barriers and the location of the slits of the switching liquid crystal panel 20 are determined in accordance with the location coordinates of the viewer 90. The arithmetic circuit 42 supplies the determined barrier lighting information to the switching liquid crystal panel driver circuit 43.

The switching liquid crystal panel driver circuit 43 drives the switching liquid crystal panel 20 based on the information supplied by the arithmetic circuit 42 (step S4). Steps S1 to S4 are then repeated.

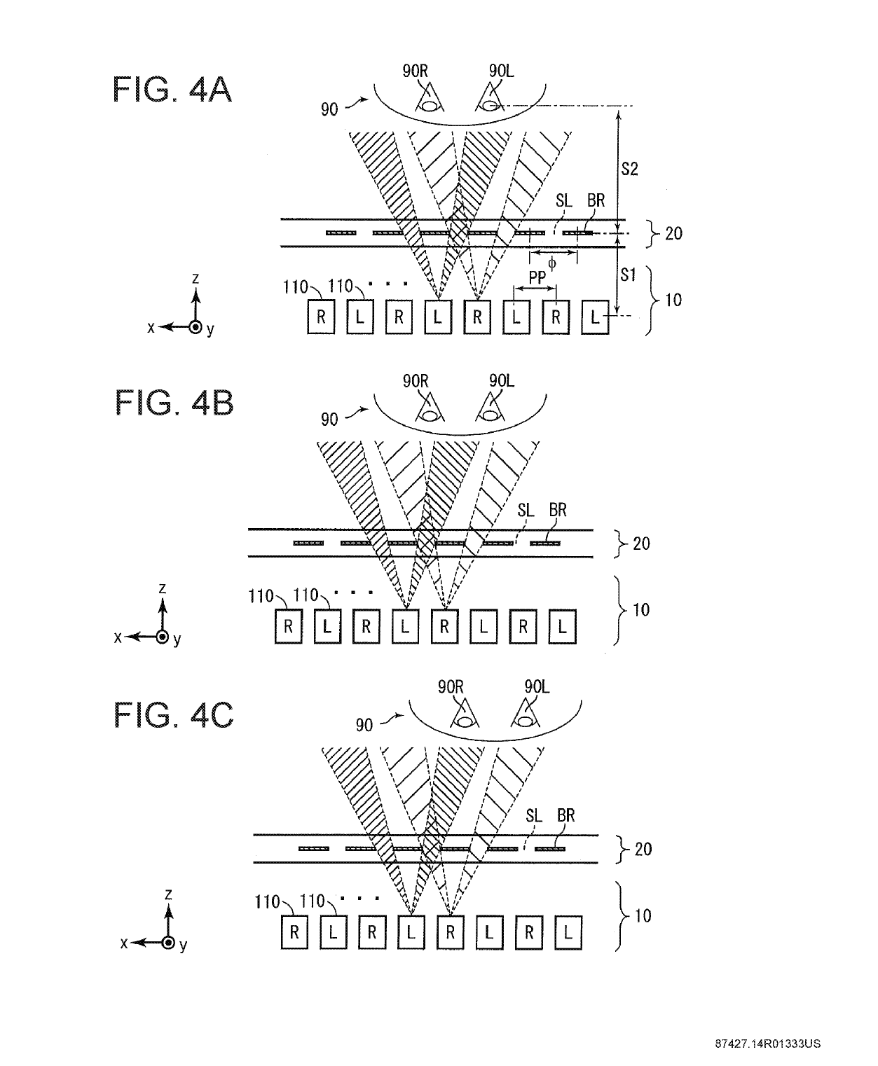

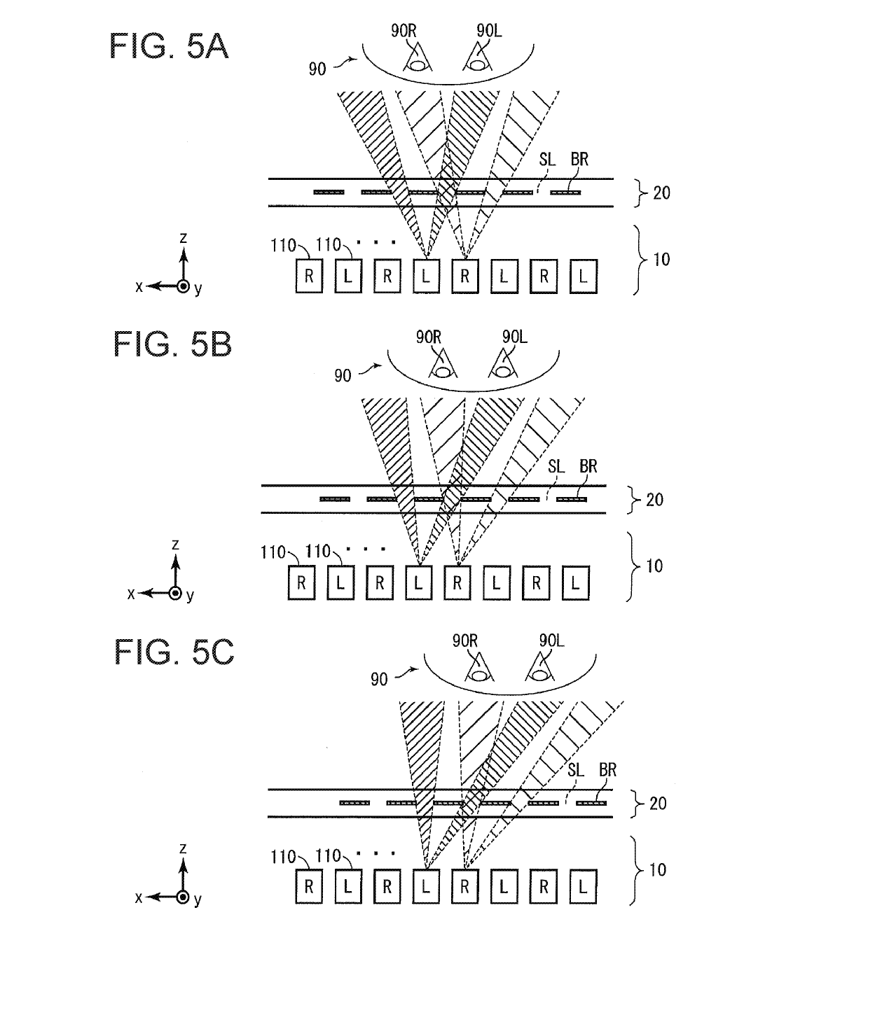

Next, FIGS. 4A to 4C and 5A to 5C will be used to explain the principles of the stereoscopic display performed by the stereoscopic display device 1.

First, a scenario in which the barrier lighting state is fixed will be described with reference to FIGS. 4A to 4C. The display panel 10 includes a plurality of pixels 110. Right-eye images (R) and left-eye images (L) are alternately displayed in the horizontal direction by the pixels 110. The switching liquid crystal panel 20 has barriers BR that block light and slits SL that transmit light formed with prescribed gaps therebetween. As shown in FIG. 4A, this allows the right-eye images (R) to only be shown to the right eye 90R of the viewer 90 and the left-eye images (L) to only be shown to the left eye 90L of the viewer 90. This makes it possible to create a three-dimensional experience for the viewer 90.

Assuming that S1 is the distance from the display surface of the display panel 10 to the barriers BR and that S2 is the distance from the barriers BR to the viewer 90, then when S2 is sufficiently greater than S1, a gap PP between the pixels 110 and a gap φ between the barriers BR is φ≈2×PP.

FIG. 4B shows a state in which the viewer 90 has moved in the horizontal direction from the position in FIG. 4A. In this case, both the right-eye image (R) and the left-eye image (L) are shown to the right eye 90R of the viewer 90. In a similar manner, both the right-eye image (R) and the left-eye image (L) are shown to the left eye 90L of the viewer 90. In other words, crosstalk occurs and a three-dimensional experience cannot be created for the viewer 90.

FIG. 4C shows a state in which the viewer 90 has moved even more in the horizontal direction from the position in FIG. 4B. In this case, the left-eye image (L) is shown to the right eye 90R of the viewer 90, and the right-eye image (R) is shown to the left eye 90L of the viewer 90. This scenario leads to a reverse viewing state in which images that are supposed have depth are seen upfront and conversely images that are supposed to be seen upfront have depth; this makes it impossible to create a proper three-dimensional experience for the viewer 90, and instead creates a sense of incongruity.

If the viewer 90 moves in this manner, there will be repeated occurrences of normal areas that give a three-dimensional experience, crosstalk areas that cause crosstalk, and reverse viewing areas that cause a reverse viewing state. Therefore, if the barrier lighting state is fixed, the viewer 90 can only experience three-dimensional display in a limited area.

As shown in FIGS. 5A to 5C, in the present embodiment, the controller 40 changes the barrier lighting state of the switching liquid crystal panel 20 in accordance with location information (location coordinates) of the viewer 90. This makes it possible for the viewer 90 to always experience three-dimensional display and to prevent crosstalk and reverse display states.

<Configuration of the Switching Liquid Crystal Panel 20>

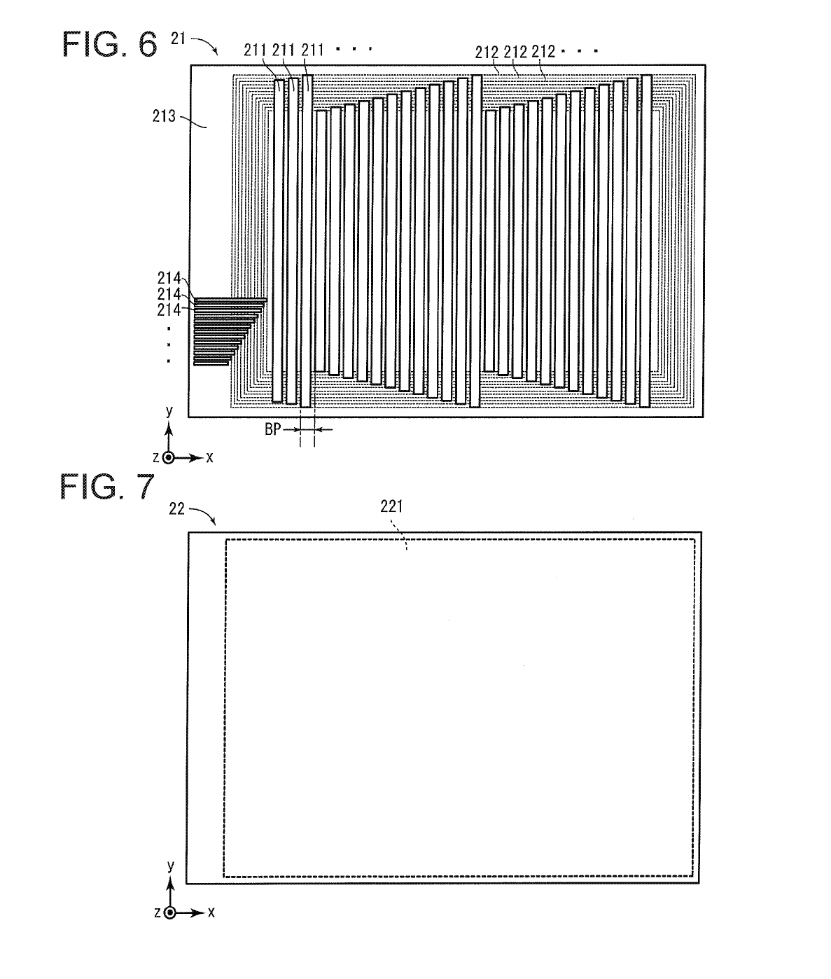

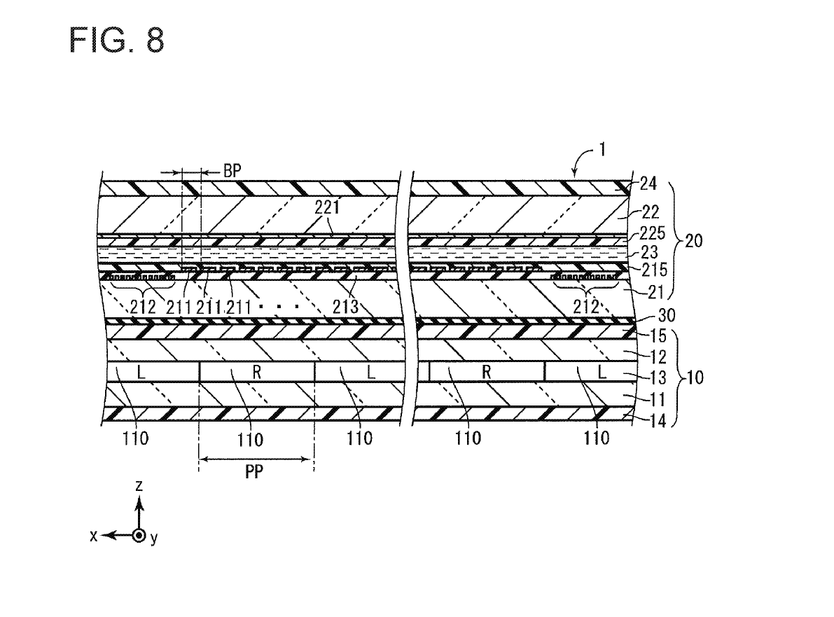

FIG. 6 is a plan view showing a configuration of a first substrate 21 of the switching liquid crystal panel 20. FIG. 7 is a plan view showing a configuration of a second substrate 22 of the switching liquid crystal panel 20. FIG. 8 is a schematic cross-sectional view of the stereoscopic display device including a detailed configuration of the switching liquid crystal panel 20.

The first substrate 21 has formed thereon a plurality of segment electrodes 211, a plurality of wiring lines 212, an insulating film 213, terminals 214, and a first alignment film 215 (FIG. 8). The second substrate 22 has formed thereon a common electrode 221 and a second alignment film 225 (FIG. 8).

The segment electrodes 211 are arranged at prescribed electrode gaps BP along the horizontal direction. In the present embodiment, the electrode gaps BP are configured such that BP≈PP/6.

Each of the segment electrodes 211 is formed so as to extend in the vertical direction. The segment electrodes 211 are transparent conductive films such as ITO (indium tin oxide), for example.

The wiring lines 212 are formed in an annular shape along the periphery of the first substrate 21. The wiring lines 212 are arranged so as to be outside the active area of the switching liquid crystal panel 20 when the display panel 10 and the switching liquid crystal panel 20 overlap. The wiring lines 212 are metal films such as aluminum, for example.

The insulating film 213 is disposed between the segment electrodes 211 and the wiring lines 212 (FIG. 8). The interlayer insulating film 123 is a transparent insulating film made of SiN, for example. Contact holes (not shown) are formed in the insulating film 213. Specific segment electrodes 211 are connected to specific wiring lines 212 via the contact holes.

The terminals 214 are formed in the same layer as the segment electrodes 211. In other words, the terminals 214 are formed in a different layer from the wiring lines 212, with the insulating film 213 interposed therebetween. Specific terminals 214 are connected to specific wiring lines 212 via the contact holes formed in the insulating film 213. As described later, the terminals 214 are made of the same material as the segment electrodes 211.

The first alignment film 215 (FIG. 8) is formed approximately on the front surface of the first substrate 21 and covers the segment electrodes 211. The first alignment film 215 is a polyimide film, for example.

The common electrode 221 is formed covering substantially the entire surface of the second substrate 22. The common electrode 221 is a transparent conductive film such as ITO, for example.

The second alignment film 225 (FIG. 8) is formed approximately on the front surface of the second substrate 22 and covers the common electrode 221. The second alignment film 225 is a polyimide film, for example.

The terminals 214 on the first substrate 21 receive signals from the controller 40 (FIG. 2). In the present embodiment, there are thirteen terminals 214 and thirteen types of signals received from the controller 40 (FIG. 2). Among these, twelve types of the signals are supplied to the segment electrodes 211 via the wiring lines 212, and the remaining one type of signal is supplied to the common electrode 221 on the second substrate 21 via a transfer (not shown).

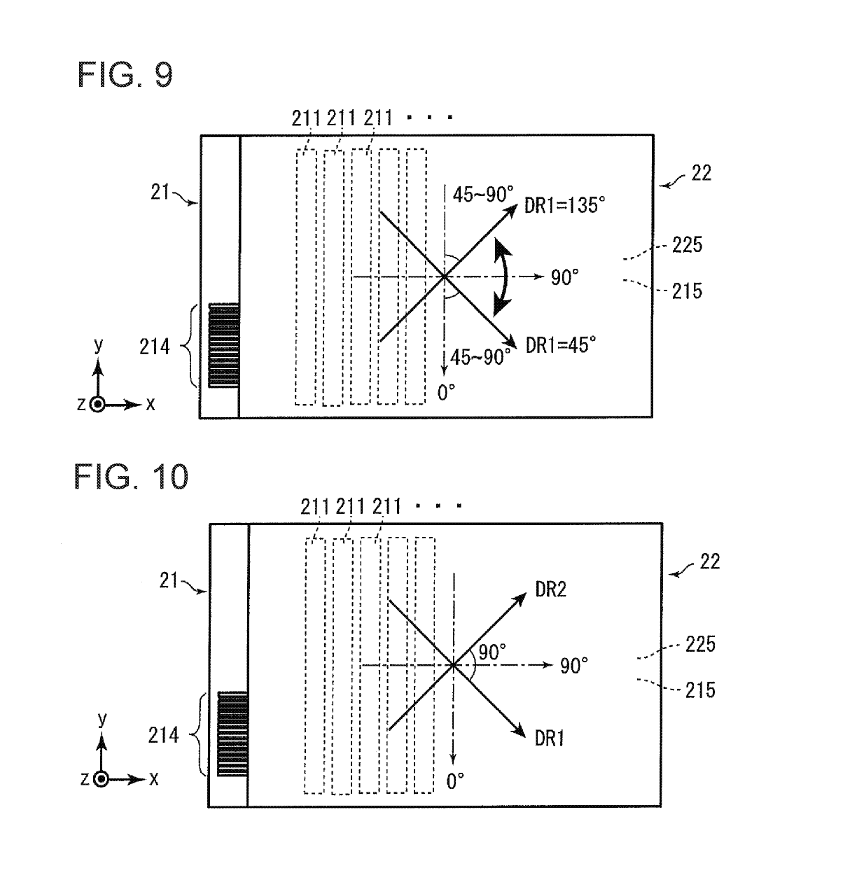

FIG. 9 is a schematic view of the relationship between the rubbing direction DR1 (first rubbing direction) of the first alignment film 215 and the segment electrodes 211. In the directions (angles) in the explanations below, the 6 o'clock direction (on the −y direction side) as seen from the viewer's side (+z direction) is 0°, and the direction rotating counterclockwise is the plus direction.

In the present embodiment, the rubbing direction DR1 is at a 45° to 90° angle to the direction (y direction) in which each of the segment electrodes 211 extends. In other words, the rubbing direction DR1 faces a direction that is 45° to 135° in a coordinate system as defined above.

FIG. 10 is a schematic view of the relationship between the rubbing direction DR1 of the first alignment film 215 and a rubbing direction DR2 (second rubbing direction) of the second alignment film 225. The rubbing direction DR1 and the rubbing direction DR2 are perpendicular to each other. In other words, the switching liquid crystal panel 20 is a twisted nematic display.

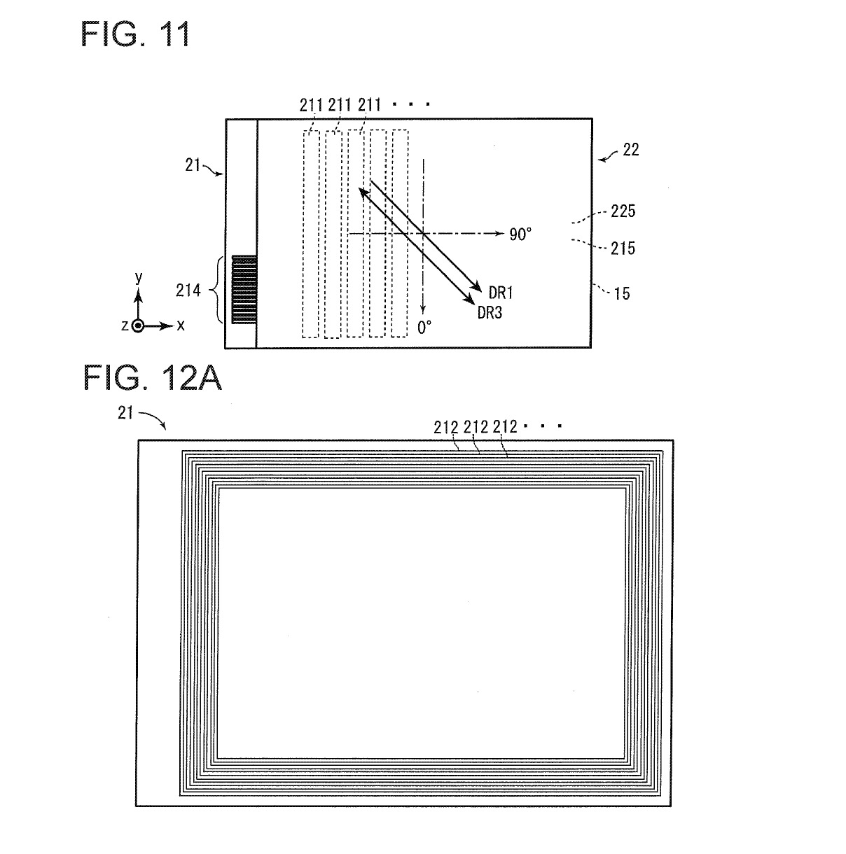

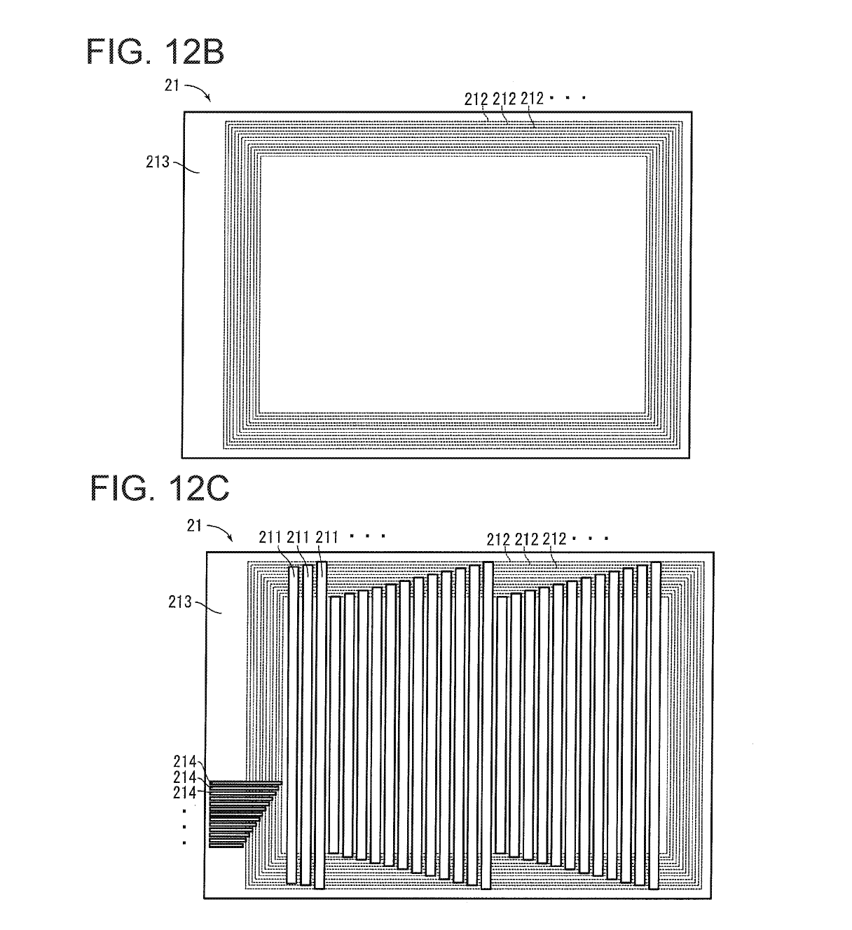

FIG. 11 is a schematic view showing the relationship between the rubbing direction DR1 of the first alignment film 215 and the transmission axis DR3 of the polarizing plate 15. The transmission axis DR3 of the polarizing plate 15 is parallel to the rubbing direction DR1.

The transmission axis of the polarizing plate 24 (FIG. 8) is orthogonal to the transmission axis DR3 of the polarizing plate 15, as already explained. Accordingly, the transmission axis of the polarizing plate 24 is parallel to the rubbing direction DR2 (FIG. 10) of the second alignment film 225.

<Method of Manufacturing Switching Liquid Crystal Panel 20>

An example of a method of manufacturing the switching liquid crystal panel 20 will be described below with reference to FIGS. 12A to 12C.

First, as shown in FIG. 12A, the wiring lines 212 are formed on the first substrate 21. The wiring lines 212 are deposited via sputtering, for example, and patterned via photolithography.

Next, as shown in FIG. 12B, the insulating film 213 is formed covering the wiring lines 212. The insulating film 213 is deposited via CVD (chemical vapor deposition), for example. In the insulating film 213, photolithography or the like is used to form contact holes in prescribed locations.

Next, as shown in FIG. 12C, the segment electrodes 211 and terminals 214 are formed. In the present embodiment, the segment electrodes 211 and terminals 214 are both made of the same material. The segment electrodes 211 and terminals 214 are deposited via sputtering or CVD, for example, and patterned via photolithography. Simultaneously depositing and patterning the segment electrodes 211 and terminals 214 in this manner can reduce the number of manufacturing steps. However, the segment electrodes 211 and terminals 214 may instead be formed separately, and in such a case, may be formed of differing materials.

Next, the first alignment film 215 (FIG. 8) is formed covering the segment electrodes 211 and terminals 214. The first alignment film 215 is deposited via a printing method, for example. The first alignment film 215 is rubbed in the rubbing direction DR1.

The above is one example of a method of manufacturing the first substrate 21. The second substrate 22 can be manufactured by depositing the common electrode 221 on the substrate via sputtering or CVD and then forming the second alignment film 225 via a method similar to the first alignment film 215, for example.

<Method of Driving Switching Liquid Crystal Panel 20>

Next, a method of driving the switching liquid crystal panel 20 will be explained. FIG. 13 is a cross-sectional view schematically showing one barrier lighting state displayed on the switching liquid crystal panel 20. In FIG. 13, the wiring lines 212, insulating layer 213, and the like are omitted.

As described above, 12 types of signals are supplied to the segment electrodes 211. In FIG. 13, the characters 211A, 211B, . . . , 211L are added to the segment electrodes 211. Different types of signals are respectively supplied to the segment electrodes 211A, 211B, . . . , 211L. The common electrode 221 receives a different type of signal than the segment electrodes 211A, 211B, . . . , 211L.

The controller 40 (FIG. 2) controls the potential of the segment electrodes 211A, 211B, . . . , 211L and the common electrode 221 in order to generate an electric field in the liquid crystal layer 23 and form barriers BR and slits SL. In the example in FIG. 13, barriers BR are formed at locations overlapping the segment electrodes 211A to 211C and 211J to 211L, and slits SL are formed at locations overlapping the segment electrodes 211D to 211I.

FIG. 14A is one example of a waveform diagram of signals supplied to the respective electrodes in order to put the switching liquid crystal panel 20 into the barrier lighting state shown in FIG. 13. Vₐ, V_{b}, . . . , V_{L} are the signals respectively supplied to the segment electrodes 211A, 211B, . . . , 211L. V_{COM} is the signal supplied to the common electrode 221.

In the example shown in FIG. 14A, V_{A}, V_{B}, V_{L}, and V_{COM} are each binary rectangular waveforms having V_{high} and V_{low}. In this example, V_{COM} and V_{D} to V_{I} are the same phase, and V_{COM}, V_{A} to V_{C}, and V_{J} to V_{L} are opposite phases.

This generates differences in potential |V_{high}−V_{low}| between the common electrode 221 and respective segment electrodes 211A to 211C and 211J to 211L. Meanwhile, the difference in potential between the common electrode 221 and the respective segment electrodes 211D to 211I is approximately zero. As described above, the switching liquid crystal panel 20 is a normally white display. Therefore, barriers BR are formed at locations overlapping the segment electrodes 211A to 211C and 211J to 211L, and splits SL are formed at locations overlapping the segment electrodes 211D to 211I.

FIG. 14B is another example of a waveform diagram of signals supplied to the respective electrodes in order to put the switching liquid crystal panel 20 into the barrier lighting state shown in FIG. 13. In the example shown in FIG. 14B, V_{COM} and V_{D} to V_{I} are fixed values of reference potential V₀. Meanwhile, V_{A} to V_{C} and V_{J} to V_{L} are binary rectangular waveforms of V₀+Vₐ and V₀−Vₐ.

In this example, differences in potential |Va| are generated between the common electrode 221 and respective segment electrodes 211A to 211C and 211J to 211L. Meanwhile, the difference in potential between the common electrode 221 and the respective segment electrodes 211D to 211I is approximately zero.

FIG. 14C is yet another example of a waveform diagram of signals supplied to the respective electrodes in order to put the switching liquid crystal panel 20 into the barrier lighting state shown in FIG. 13. In the example shown in FIG. 14C, V_{COM} and V_{D} to V_{I} are binary rectangular wavelengths of V₀+Vₐ and V₀−Vₐ. Meanwhile, V_{A} to V_{C} and V_{J} to V_{L} are fixed values of reference voltage V₀.

In this example, as above, differences in potential |Va| are generated between the common electrode 221 and respective segment electrodes 211A to 211C and 211J to 211L. Moreover, the difference in potential between the common electrode 221 and the respective segment electrodes 211D to 211I is approximately zero.

In this manner, the controller 40 (FIG. 2) controls the potential of the segment electrodes 211A, 211B, . . . , 211L and the common electrode 221 in order to form the barriers BR and slits SL. The present embodiment makes it possible to move the barriers BR and slits SL, with the smallest increments being the electrode gaps BP.

As the electrode gap BP becomes smaller, the barriers BR and slits SL can be moved very precisely. In order to maintain a low level of crosstalk, it is preferable that the electrode gap BP be reduced and that the barriers BR and slits SL are able to be moved precisely. Meanwhile, as shown in FIG. 13, the electrode gap BP is the sum of the width W of the segment electrodes 211 and the space S between electrodes. There are cases in which the response of the liquid crystal layer 23 in the regions between electrodes (inter-wire regions) is poor and the light-blocking properties of the barriers BR are reduced. If the light-blocking properties of the barriers BR are low, then a portion of the left-eye image is seen by the right eye and a portion of the right-eye image is seen by the left eye. In other words, crosstalk increases. Accordingly, it is preferable that the space S between electrodes is small.

However, if the space S is made too small, leakage can easily occur between adjacent segment electrodes 211, and the yield of the switching liquid crystal panel 20 will drop. As the electrode gap BP is reduced while maintaining a fixed amount of space S between the electrodes, the proportion of space S between the segment electrodes 211 to the width W of the electrodes increases. Thus, the amount of area in which the light-blocking properties of the barriers BR is insufficient increases.

It should be noted that, when using a general twisted nematic liquid crystal display device, the inter-wire regions are shielded by a black matrix, and thus the responsiveness of the liquid crystal molecules in the inter-wire regions is not an issue. However, in the switching liquid crystal panel 20, the electrode gap BP is smaller than the pixel pitch PP. Therefore, placing a black matrix between the segment electrodes 211 would markedly lower the aperture ratio. Thus, for the switching liquid crystal panel 20, improving the responsiveness of the liquid crystal in the inter-wire regions is an issue.

<Relationship Between Rubbing Direction and Crosstalk>

The angular distribution of the light-blocking properties of the barriers BR changes via the rubbing direction of the alignment film 215 and the alignment film 225. The angular distribution of the light-blocking properties of the barriers BR changing also changes the angular distribution of crosstalk. The relationship between the rubbing direction and crosstalk will be explained below.

A plurality of stereoscopic display devices were fabricated with different rubbing directions of the alignment film of the switching liquid crystal panel. Except for the rubbing direction of the alignment film of the switching liquid crystal panel, the display devices were fabricated according to the configuration of the stereoscopic display device 1 (FIG. 1).

The thickness of the TFT substrate 11 and CF substrate 12 was set at 300 μm. The thickness of the polarizing plate 14 and polarizing plate 15 was set at 130 μm. The thickness of the first substrate 21 and second substrate 22 was set at 300 μm. The thickness (cell gap) of the liquid crystal layer 23 was set to 4.6 μm, the birefringence Δn of the liquid crystal to 0.11, and the retardation to 506 nm. The thickness of the adhesive resin 30 was set to 50 μm.

The display panel 10 was a liquid crystal display panel of 3.9 inches diagonally (84.6 mm horizontally and 50.76 mm vertically), 800 pixels in the horizontal direction, and 240 pixels in the vertical direction (720 sub-pixels). Each of the pixels 110 in this liquid crystal display panel includes three sub-pixels arranged in the vertical direction that display red, green, and blue, respectively. The pixel pitch PP in the horizontal direction of the liquid crystal panel is 105.75 μm, and the pixel pitch in the vertical direction is 211.5 μm (sub-pixel pitch of 70.5 μm). The switching liquid crystal panel 20 had the electrode gap BP set to ≈17.6 μm (width W of electrodes≈12.6 μm, space S between electrodes=5 μm).

FIG. 15 will be used to quantitatively define crosstalk. FIG. 15 shows angle properties of the luminance of the stereoscopic display device when the barrier lighting state is fixed. Luminance A_{L} is the luminance measured for the right-eye image during black display and the left-eye image during white display at angle θ<0. Luminance A_{R} is the luminance measured on the same screen at angle θ>0. Luminance B_{L} is the luminance measured for the right-eye image during white display and the left-eye image during black display at angle θ<0. Luminance B_{R} is the luminance measured on the same screen at angle θ>0. Luminance C_{L} is the luminance measured for both the right-eye image and the left-eye image during black display at angle θ<0. Luminance C_{R} is the luminance measured on the same screen at angle θ>0.

At this time, the crosstalk XT (L) of the left eye is defined by the following formula.

$$XT ( L ) [ \% ] = \frac{{B}_{L} ( θ ) - {C}_{L} ( θ )}{{A}_{L} ( θ ) - {C}_{L} ( θ )} \times 100 \qquad 〈 \#1 〉$$

In a similar manner, the crosstalk XT (R) of the right eye is defined by the following formula.

$$XT ( R ) [ \% ] = \frac{{A}_{R} ( θ ) - {C}_{R} ( θ )}{{B}_{R} ( θ ) - {C}_{R} ( θ )} \times 100 \qquad 〈 \#2 〉$$

FIG. 16 shows angle properties of the crosstalk XT (L) of the left eye and crosstalk XT (R) of the right eye. The left-eye crosstalk XT (L) takes the smallest value XT_{MIN} (L) at angle-θ₀ and gradually increases further away from angle-θ₀. In a similar manner, the right-eye crosstalk XT (R) takes the smallest value XT_{MIN} (R) at angle+θ₀ and gradually increases further away from angle+θ₀.

FIG. 17 is a table summarizing the relationship between rubbing direction and crosstalk. The “rubbing axis (DR1/DR2)” column shows rubbing direction DR1 and rubbing direction DR2. For example, “0°/90°” indicates that the rubbing direction DR1 is 0° and that the rubbing direction DR2 is 90°.

The “rubbing axis setting” column schematically shows the rubbing direction DR1 and rubbing direction DR2. The white arrows represent the direction of rotation of the long molecular axes of the liquid crystal molecules from the first substrate 21 towards the second substrate 22 in a state where no voltage is being applied. The dotted arrows represent a direction (viewing angle direction) parallel to the long molecular axes in the center of the thickness direction of the liquid crystal layer 23.

The “alignment photographs” column shows microscopic photographs of the barrier lighting state of the switching liquid crystal panel 20. The “inter-wire light leakage” column shows the magnitude of light leakage between barriers when the stereoscopic display device is viewed from the front.

The “XT_{MIN} (L)/XT_{MIN} (R)” column shows the values of XT_{MIN} (L) and XT_{MIN} (R). For example, “1.4/1.6” means that XT_{MIN} (L) is 1.4% and XT_{MIN} (R) is 1.6%.

The “XT_{MAX} (−12° to 12°)” column shows the maximum XT (L) and XT (R) values in a range of −12°≦θ≦12° during observation of the stereoscopic display device while changing the barrier lighting state and while the lighting location of the barrier is switched at an ideal location. For example, “1.6/2.1” means that the maximum XT (L) value in the range of −12°≦θ≦12° is 1.6%, and the maximum XT (R) value in the same range is 2.1%.

The “barrier movement (right→left)” column shows the response speed of the barrier lighting state during movement from right to left. The “barrier movement (left→right)” column shows the response speed of the barrier lighting state during movement from left to right. “⊚” indicates that the response was smooth. “∘” indicates that the response speed was slightly slower than “⊚.” “x” indicates that the response was slow. In the stereoscopic display device with the rubbing axis of “0°/90°”, when moving from left to right, the lighting of the right edge was slow. Furthermore, in the stereoscopic display device with the rubbing axis of “90°/180°”, when moving from right to left, light leakage occurred in an amount approximately equal to the space S between the electrodes.

The “barrier edge alignment state” column shows the alignment state of the barrier edge. “⊚” indicates that the alignment state of the barrier edge was favorable. “x” indicates that there were some unfavorable alignment sections in the alignment state of the barrier edge.

FIGS. 18A to 18E show overlapping crosstalk properties when the barrier lighting state is changed in each stereoscopic display device. FIG. 19 is a graph showing the relationship between rubbing direction D1 and XT_{MIN} (L) & XT_{MIN} (R). In FIG. 19, the solid square (“▪” mark) represents XT_{MIN} (R), and the solid circle (“” mark) represents XT_{MIN} (L). FIG. 20 is a graph showing the relationship between rubbing direction D1 and XTMAX (−12° to 12°). In FIG. 20, the solid square (“▪” mark) represents the maximum XT (R) value in the range of −12°≦θ≦12°, and the solid circle (“” mark) represents the maximum XT (L) value in the same range.

FIGS. 21A to 21E show contrast properties of each of the switching liquid crystal panels 20. FIG. 22 is a graph showing contrast properties along the line A-A′ in FIG. 21A in each switching liquid crystal panel 20. The curved line C1 shows contrast properties for the switching liquid crystal panel 20 with a rubbing direction D1 of 0°. The curved line C2 shows contrast properties for the switching liquid crystal panel 20 with a rubbing direction D1 of 27°. The curved line C3 shows contrast properties for the switching liquid crystal panel 20 with a rubbing direction D1 of 45°. The curved line C4 shows contrast properties for the switching liquid crystal panel 20 with a rubbing direction D1 of 63°. The curved line C5 shows contrast properties for the switching liquid crystal panel 20 with a rubbing direction D1 of 90°.

As shown in FIG. 17, the closer the rubbing direction D1 is to 90°, or namely, the greater the angle of the rubbing direction D1 to the extension direction of the segment electrodes 211, the less inter-wire light leakage there is. This is due to the following. When the angle of the rubbing direction D1 to the extension direction of the segment electrodes 211 is large enough, rubbing becomes insufficient at the borders of areas where the segment electrodes 211 are formed and areas where the segment electrodes are not formed. In areas where rubbing is insufficient, the liquid crystal molecules become unstable and over-responsive, even if the electric field is small. This results in an improvement in the light-blocking properties of the inter-wire regions.

Reducing inter-wire light leakage makes it possible to keep crosstalk to a minimum. As shown in FIG. 19, if the rubbing direction D1 is 45° or greater, then both XT_{MIN} (L) and XT_{MIN} (R) can be set to 1.2 or less. As shown in FIG. 20, XT_{MAX} (−12° to 12°) is lowest when the rubbing direction D1 is 63°.

As shown in FIG. 17, when the rubbing direction D1 is 0° or 90°, the lighting of the barrier edge is disrupted during changing of the barrier lighting state. Furthermore, when the rubbing direction D1 is 90°, disruptions occur in the alignment of the barrier edge.

As shown in FIGS. 21A to 21E and FIG. 22, the closer the rubbing direction D1 is to 90°, or namely, the greater the angle of the rubbing direction D1 to the extension direction of the segment electrodes 211, the higher contrast will be. If the contrast of the switching liquid crystal panel 20 becomes higher, then the shielding rate of the barriers and the transmittance of the slits will be higher. In other words, it is possible to further reduce crosstalk.

For general twisted nematic liquid crystal display devices, there is a correlation between the rubbing direction of the alignment film and contrast distribution, and when the rubbing direction is changed, the contrast distribution merely rotates. This is because a black matrix is placed in the inter-wire regions where the alignment state is susceptible to disruption, and the areas where alignment is easily disrupted are hidden. As already described, the switching liquid crystal panel 20 does not have a black matrix in the inter-wire regions. Therefore, as shown in FIGS. 21A to 21E, when the rubbing direction of the alignment film is changed, the contrast distribution does not rotate, but instead exhibits a distinctive contrast distribution.

The stereoscopic display device 1 according to Embodiment 1 of the present invention was described above. As described above, if the angle between the rubbing direction D1 (first rubbing direction) and the direction (second direction) in which the segment electrodes 211 extend is 45° to 90°, then inter-wire light leakage can be markedly reduced and crosstalk can be kept to a minimum. Moreover, if the angle of the rubbing direction D1 to the extension direction of the segment electrodes 211 is greater than or equal to 45° and less than 90°, then the response of the barrier lighting state can be made smooth. The angle of the rubbing direction D1 to the extension direction of the segment electrodes 211 is most preferably 63°.

In the present embodiment, an example was described in which 12 types of signals are supplied to the segment electrodes 211. However, the number of signals supplied to the segment electrodes 211 can be chosen at will. Furthermore, in the present embodiment, a scenario was described in which the width of the barriers BR is equal to the width of the slits SL, but the proportion of the width of the barriers BR to the width of the slits SL can be chosen at will.

### Embodiment 2

A stereoscopic display device according to Embodiment 2 of the present invention differs from the stereoscopic display device 1 in the direction of the transmission axis of the polarizing plate 15 and polarizing plate 25.

FIG. 23 is a schematic view showing a relationship between the rubbing direction DR1 of the first alignment film 215 and the transmission axis DR3 of the polarizing plate 15 in Embodiment 2. In the present embodiment, the transmission axis DR3 of the polarizing plate 15 is perpendicular to the rubbing direction DR1 (first rubbing direction). Although omitted in the drawing, the transmission axis of the polarizing plate 24 is perpendicular to the rubbing direction DR2 (second rubbing direction).

The specific underlying principles are unclear, but as shown in the present embodiment, when the rubbing direction and the transmission axis of the polarizing plate adjacent thereto are perpendicular to each other, the lens effect (light focusing effect) of the switching liquid crystal panel 20 is greater. If the lens effect of the switching liquid crystal panel 20 becomes greater, then in FIG. 15, the values of A_{L} close to −θ₀ and B_{R} close to +θ₀ increase. Thus, crosstalk is further reduced.

FIG. 24 is a graph showing the crosstalk properties of the stereoscopic display device of Embodiment 1 and the stereoscopic display device of Embodiment 2. In FIG. 24, the dotted line shows crosstalk properties of the stereoscopic display device 1 according to Embodiment 1, and the solid line shows crosstalk properties of the stereoscopic display device according to Embodiment 2. The rubbing direction DR1 for both was set at 63°. In the stereoscopic display device 1 in Embodiment 1, XT_{MIN} (L)=0.7% and XT_{MIN} (R)=0.4%. In contrast, in the stereoscopic display device in Embodiment 2, XT_{MIN} (L)=0.6% and XT_{MIN} (R)=0.3%. In this manner, the present embodiment makes it possible to achieve an even lower level of crosstalk.

### Embodiment 3

FIG. 25 is a schematic cross-sectional view of a stereoscopic display device 2 of Embodiment 3 of the present invention. The stereoscopic display device 2 includes a switching liquid crystal panel 20A instead of the switching liquid crystal panel 20.

The switching liquid crystal panel 20A differs from the switching liquid crystal panel 20 in the configuration of the first substrate 21.

In the switching liquid crystal panel 20 (FIG. 8), the wiring lines 212, insulating layer 213, and segment electrodes 211 are arranged in this order from the first substrate 21 side. In contrast, in the switching liquid crystal panel 20A, the segment electrodes 211, insulating layer 213, and wiring lines 212 are arranged in this order from the first substrate 21 side. In other words, in the present embodiment, the segment electrodes 211 are placed closer to the first substrate 21 than the insulating layer 213 is.

The present embodiment can also achieve effects similar to Embodiment 1 and Embodiment 2. In the present embodiment, the insulating layer 23 is placed in-between the segment electrodes 211 and the liquid crystal layer 23, but as long as the thickness of the insulating layer 23 is approximately 200 nm to 450 nm, the performance of the switching liquid crystal panel 20A will not be affected.

### Embodiment 4

FIG. 26 is a schematic cross-sectional view of a stereoscopic display device 3 of Embodiment 4 of the present invention. The stereoscopic display device 3 differs from the stereoscopic display device 1 in the positional relationship between the display panel 10 and the switching liquid crystal panel 20. In the stereoscopic display device 3, the display panel 10 is placed closer to the viewer 90 than the switching liquid crystal panel 20 is.

According to the present embodiment, light from the light source is first divided by the switching liquid crystal panel 20, and then passes through the display panel 10. The light that has been divided by the switching liquid crystal panel 20 is scattered or diffracted when passing through the display panel 10. The configuration of the stereoscopic display device 3 lowers the dividing properties but smooths the angular properties of brightness. This reduces the change in brightness recognizable when the barrier lighting state is switching when the user moves.

### Other Embodiments

Embodiments of the present invention were described above, but the present invention is not limited to the above-mentioned embodiments, and various modifications are possible within the scope of the present invention. In addition, the respective embodiments can be appropriately combined.

In the respective embodiments described above, an example was described in which a liquid crystal panel was used as the display panel 10. However, instead of a liquid crystal panel, it is possible to use an organic EL (electroluminescent) panel, a MEMS (microelectromechanical system) panel, a plasma display panel, or the like.

1. A stereoscopic display device, comprising:
a display panel;
a switching liquid crystal panel overlapping the display panel;
a location sensor that acquires location information of a viewer; and
a controller that controls the switching liquid crystal panel,
wherein the switching liquid crystal panel includes:
a first substrate and a second substrate facing each other;
a liquid crystal layer between the first substrate and the second substrate;
a plurality of segment electrodes arranged on the first substrate with prescribed gaps therebetween along a first direction, each extending in a second direction orthogonal to the first direction;
a first alignment film covering the plurality of segment electrodes and rubbed in a first rubbing direction that is at a 45° to 90° angle to the second direction;
a common electrode on the second substrate; and
a second alignment film covering the common electrode and rubbed in a second rubbing direction orthogonal to the first rubbing direction, and
wherein the controller changes a potential of the plurality of segment electrodes in accordance with the location information of the viewer.

2. The stereoscopic display device according to claim 1,
wherein the display panel includes a first polarizing plate on a side facing the switching liquid crystal panel, and the switching liquid crystal panel further includes a second polarizing plate on a side of the second substrate that is on a side away from the display panel,
wherein the first polarizing plate has a transmission axis parallel to the first rubbing direction, and
wherein the second polarizing plate has a transmission axis parallel to the second rubbing direction.

3. The stereoscopic display device according to claim 1,
wherein the display panel includes a first polarizing plate on a side facing the switching liquid crystal panel, and the switching liquid crystal panel further includes a second polarizing plate on a side of the second substrate that is on a side away from the display panel,
wherein the first polarizing plate has a transmission axis perpendicular to the first rubbing direction, and
wherein the second polarizing plate has a transmission axis perpendicular to the second rubbing direction.

4. The stereoscopic display device according to claim 1, wherein the display panel is a liquid crystal panel.
